(19) United States
(12) Patent Application Publication
(10) Pub. No.: US 2008/0035617 A1
(43) Pub. Date: Feb. 14, 2008

(54) METHOD FOR PROCESSING BRITTLE SUBSTRATES WITHOUT MICRO-CRACKS

(75) Inventors: CHEN-TSU FU, Chu-Nan (TW); CHUN-KAI HUANG, Chu-Nan (TW); HSIEN-TANG CHEN, Chu-Nan (TW); JUI-WEN FANG, Chu-Nan (TW); FANG-SHIUAN KUO, Chu-Nan (TW); TSUNG-FU HSU, Chu-Nan (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 11/626,037

(22) Filed: Jan. 23, 2007

(30) Foreign Application Priority Data
Aug. 11, 2006 (CN) 200610062074.3

(51) Int. Cl. B23K 26/38; B23K 26/40

(52) U.S. Cl. 219/121.69

(57) ABSTRACT

A method for processing a brittle substrate includes first providing a brittle substrate having a substrate surface. Then applying a first laser beam onto the brittle substrate surface to form a pre-cut groove in the brittle substrate, the first laser beam being generated by a solid-state laser device. A second laser beam is then applied onto the brittle substrate surface along the precut groove to heat the brittle substrate, the second laser beam being generated by a gas laser device. Finally, a coolant is applied onto the brittle substrate along the pre-cut groove so as to cause formation of a through crack in the brittle substrate. The first laser beam can be generated by a solid-state laser device, the first laser beam should be of narrow diameter and high energy density, so the first laser beam can form a pre-cut groove rapidly and accurately without generation of micro-cracks, in addition, the pre-cut groove should have a better uniformity and linearity.

### BACKGROUND OF THE INVENTION

1. Field of the Invention

The present invention generally relates to a method for processing brittle substrates without micro-cracks being formed on the substrates.

2. Description of Related Art

Conventional techniques for cutting a sheet of brittle substrate, such as glass, glass-ceramic and ceramic substrate, comprises two principal methods. One is mechanical scribing which employs a hard device, such as a diamond tip, to create score marks on the surface of the brittle material, and is then broken along the score marks. The other technique is laser scribing, which includes: making a line on the brittle substrate with a gas laser or a hard device, heating a zone of the substrate along the predetermined line to a temperature below the softening point of the substrate with a continuous wave laser, such as a CO₂ laser, and quickly quenching the heated substrate with a coolant, such as air or a liquid such as water. The heating-quenching process induces a tiny surface crack that propagates to localize compression-tension stress effects and the sheet of substrate is then finally broken under external thermal or mechanical stress.

However, in the above two method, when forming the line, micro-cracks, such as median crack, radial crack and/or lateral crack, will be form in the substrate. The substrate may be damaged by the micro-cracks. In addition, the substrate may be evidently damaged because of micro-cracks when the substrate is thin.

What is needed, therefore, is a method for processing a brittle substrate approximate without making micro-cracks.

### SUMMARY OF THE INVENTION

A method for processing a brittle substrate includes first providing a brittle substrate having a substrate surface. Then applying a first laser beam onto the brittle substrate surface to form a pre-cut groove in the brittle substrate, the first laser beam being generated by a solid-state laser device. A second laser beam is then applied onto the brittle substrate surface along the precut groove to heat the brittle substrate, the second laser beam being generated by a gas laser device. Finally, a coolant is applied onto the brittle substrate along the pre-cut groove so as to cause formation of a through crack in the brittle substrate.

The first laser beam can be generated by a solid-state laser device, the first laser beam should be of narrow diameter and high energy density, so the first laser beam can form a pre-cut groove rapidly and accurately without generation of micro-cracks, in addition, the pre-cut groove should have a better uniformity and linearity.

Other advantages and novel features will become more apparent from the following detailed description of the present invention, when taken in conjunction with the accompanying drawings.

### BRIEF DESCRIPTION OF THE DRAWINGS

Many aspects of the present method for processing a brittle substrate can be better understood with reference to the following drawings. The components in the drawings are not necessarily drawn to scale, the emphasis instead being placed upon clearly illustrating the principles of the present method.

FIG. 1 is a schematic, sectional view of an apparatus for processing a brittle substrate in accordance with a first preferred embodiment;

FIG. 2 is schematic, sectional cross-sectional views of FIG. 1, taken along line II-II thereof; and

FIG. 3 is a schematic, a top-down view of a brittle substrate being processed in accordance with the first preferred embodiment.

Corresponding reference characters indicate corresponding parts throughout the drawings. The exemplifications set out herein illustrate at least one preferred embodiment of the present method, in one form, and such exemplifications are not to be construed as limiting the scope of the invention in any manner.

### DETAILED DESCRIPTION OF THE EMBODIMENTS

Reference will now be made to the drawings to describe preferred embodiments of the present method for cutting a brittle substrate in detail.

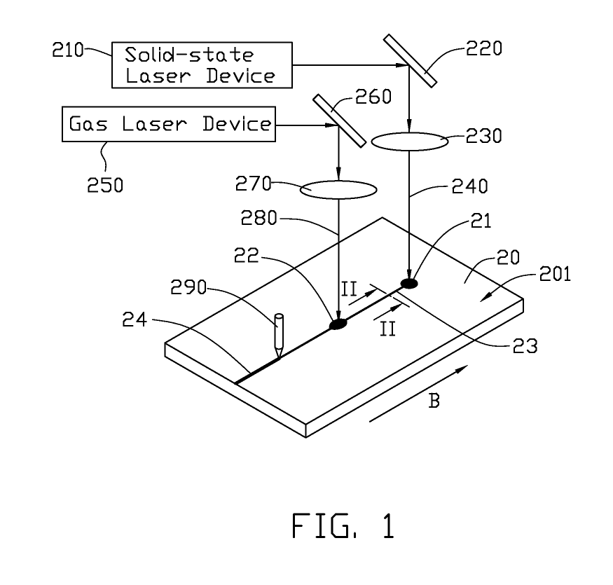

Referring to FIG. 1, a method for processing a brittle substrate, in accordance with a first preferred embodiment, is shown. The method for processing a brittle substrate includes the following steps:

Step 1: providing a brittle substrate 20 having a substrate surface 201. The brittle substrate 20 is placed on a holding plate (not shown). The brittle substrate 20 is comprised of a material, which can include, for example, glass, ceramic, quartz, and semi-conductor material.

Step 2: applying a first laser beam 240 onto the brittle substrate surface 201 to form a pre-cut groove 23 in the brittle substrate 20, the first laser beam 240 being generated from a solid-state laser device 210.

The first laser beam 240 is reflected by a first reflector 220 and passes through a first focusing lens 230. The first laser beam 240 is focused through the first focusing lens 230 and impinges on the brittle substrate surface 201 form a first laser spot 21. The first laser beam 240 continuously heats a zone under the first laser spot 21, vaporizing material of the brittle substrate 20 to form a pre-cut groove 23 along a direction B. In this embodiment, the solid-state laser device 210 is a high-power solid-state laser device, the solid-state laser device 210 with some parameters of a specific wavelength, frequency, energy density and beam diameter will have sufficient energy to enable its pulse to impact and vaporize material of the brittle substrate 20. The solid-state laser device 210 can have the following parameters: a wavelength in an approximate range from 200 to 1064 nm, a frequency in an approximate range from 50 to 80 KHz, a pulse duration in an approximate range from 10 to 40 nanosecond, a laser beam diameter viz. diameter of the first laser spot 21 in an approximate range from 15 to 1000 microns, an energy density in an approximate range from 120 to 250 J/cm.sup.2, a power in an approximate range from 0.5 to 1.8 w. Preferably, the wavelength should bein an approximate range from 355 to 570 nm, and the laser beam diameter should be in an approximate range from 15 to 300 microns. Because depth and width of the pre-cut groove 23 corresponds to the diameter of the first laser spot 21 and the energy density, the pre-cut groove 23 can be formed rapidly and accurately without generation of the first micro-cracks by the small diameter of the first laser spot 21 and higher energy density, at the same time, the pre-cut groove 23 formed by the first laser beam 240 should have better uniformity and be more linear.

Alternatively, the first laser beam 240 may directly impinge on the surface of the brittle substrate 20 to form the pre-cut groove 23 without using the first reflector 220 and the first focusing lens 230.

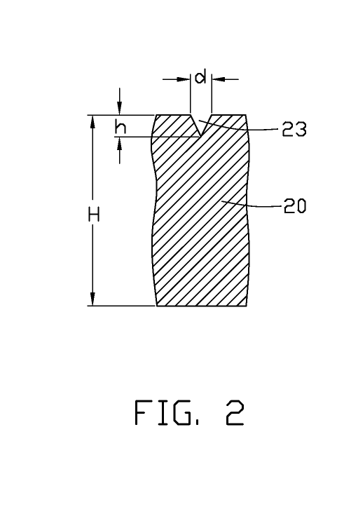

Referring to FIG. 2, in this embodiment, the pre-cut groove 23 can be a V-shaped groove. A depth ‘h’ of the pre-cut groove 23 is greater than one tenth of a thickness ‘H’ of the brittle substrate 20. A width ‘d’ of the pre-cut groove 23 should be less than 20 microns.

Step 3: applying a second laser beam 280 onto the brittle substrate surface 201 along the precut groove 23 to heat the brittle substrate 20, the second laser beam 280 being generated from a gas laser device 250.

Referring to FIG. 1 again, the second laser beam 280 that generated from a gas laser device 250 is reflected by a second reflector 260 and transmits through a second focusing lens 270. The second laser beam 280 is focused through the second focusing lens 270 and impinges on the pre-cut groove 23 to form a second laser spot 22. Thus, the pre-cut groove 23 is heated to a high temperature by the irradiation of the second laser beam 280, resulting in a local heat-expansion with a high stress concentration.

Alternatively, the second laser beam 280 may directly impinge on the pre-cut groove 23 at relative beam energy to result in a local heat-expansion with a high stress concentration without the second reflector 260 and the second focusing lens 270.

The second laser beam 280 is selected corresponding to a characteristic of absorptive wave of the brittle substrate 20. The gas laser device 250 can be selected from a group including CO₂ lasers, CO lasers, nitrogen molecular lasers and inert gas lasers to match with the material of the substrate. For example, a CO₂ laser can be selected for a glass substrate; the nitrogen molecular laser should be selected for a ceramic glass substrate etc. In this embodiment, the gas laser device 250 is a CO₂ laser, the second laser beam 280 is generated by a CO₂ laser having a wavelength of 10.6 microns.

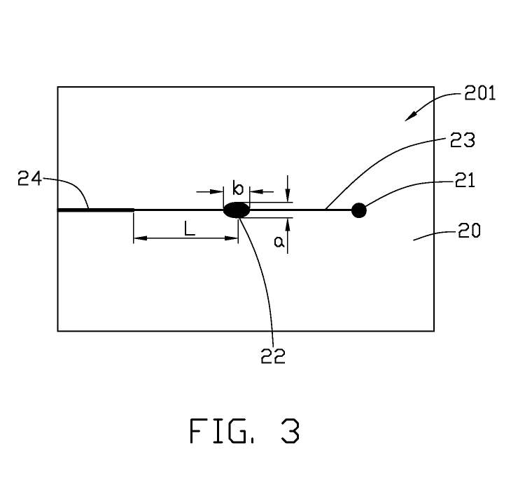

Referring to FIGS. 1 and 3, the second laser spot 22 can be a circular spot, an elliptical spot etc. In this embodiment, the second laser spot 22 should preferably be an elliptical spot. The second focusing lens 270 can include a birefringent crystal. Using a characteristic of major axis and minor axis of the elliptical spot having different refractive index can form the second laser spot 22. In addition, using a diffraction element or other elements received in the second focusing lens 270 can form the second laser spot 22 too. A direction of the pre-cut groove 23 extending is consistent with the major axis of the second laser spot 22. The major axis of the second laser spot 22 is parallel to the pre-cut groove 23; the minor axis of the second laser spot 22 is parallel to an extension direction of the pre-cut groove 23. A length of the major axis is ten times greater than that of the minor axis. A path that the second laser beam 280 moves along is consistent with the pre-cut groove 23.

Step 4: applying a coolant onto the brittle substrate 20 along the pre-cut groove 23 so as to cause a through crack in the brittle substrate 20 thus allowing the complete cutting of the brittle substrate 20.

Referring to FIG. 1, after heating the brittle substrate 20 along the pre-cut groove 23 by using the second laser beam 280, a coolant unit 290 following the second laser beam 280 sprays a coolant onto the pre-cut groove 23, so that the pre-cut groove 23 is rapidly cooled. The coolant should be at a very low temperature compared with the pre-cut groove 23, such as below 0 degrees Celsius.

By heating and cooling the pre-cut groove 23, the pre-cut groove 23 is heat-expanded and contracted and thereby high thermal stress is concentrated on the pre-cut groove 23 of the brittle substrate 20.

When the thermal stress exceeds bonding force of the material molecules of the brittle substrate, material molecules bonding is broken and cracking is generated along the pre-cut groove 23.

The generated crack is propagated along the propagation direction of the second laser beam 280, that is, perpendicularly with respect to the surface of the brittle substrate 20, so the brittle substrate 20 is completely cut.

Referring to FIG. 3 again, when the second laser beam 280 is applied to the brittle substrate 20, the coolant is applied onto a region of the brittle substrate 20 which is located at a distance ‘L’ of approximately less than 50 millimeters from the center of the second laser spot 22, preferably, the distance ‘L’ should be in an approximate range from 10 millimeters to 50 millimeters.

The coolant in the coolant unit 290 may be gas, liquid or a combination thereof. The gas coolant is selected from a group consisting of air, cooling oil, helium gas, nitrogen, CO₂ and any combination thereof. The liquid coolant is selected from a group consisting of pure water, alcohol, acetone, isopropanol, cooling oil, liquid nitrogen, liquid helium and any combinations thereof.

In this embodiment, the first laser beam 240 generated by the solid-state laser device 210 can form a pre-cut groove 23 having a better uniformity and linearity, so thus allowing control of generation of micro-cracks. So, the brittle substrate can be cut approximate without formation of micro-cracks.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A method for processing a brittle substrate comprising the steps of:
providing a brittle substrate having a substrate surface;
applying a first laser beam onto the brittle substrate surface to form a pre-cut groove in the brittle substrate, the first laser beam being generated by a solid-state laser device;
applying a second laser beam onto the brittle substrate surface along the pre-cut groove to heat the brittle substrate, the second laser beam being generated by a gas laser device; and
applying a coolant onto the brittle substrate along the pre-cut groove so as to cause formation of a through crack in the brittle substrate.

2. The method of claim 1, wherein the brittle substrate is comprised of a material selected from the group consisting of glass, ceramic, quartz, and semi-conductor.

3. The method of claim 1, wherein the first laser beam has a wavelength in an approximate range from 200 nanometers to 1064 nanometers.

4. The method of claim 1, wherein the first laser beam forms a first laser spot on the substrate surface of the brittle substrate, a diameter of the first laser spot being in an approximate range from 15 to 1000 microns.

5. The method of claim 1, wherein a depth of the pre-cut groove is greater than approximately one tenth of a thickness of the brittle substrate.

6. The method of claim 1, wherein a width of the pre-cut groove is less than 20 microns.

7. The method of claim 1, wherein the second laser beam forms a second elliptical laser spot on the pre-cut groove, the second elliptical laser spot having a major axis parallel to the pre-cut groove.

8. The method of claim 7, wherein a length of the major axis is ten times greater than that of the minor axis.

9. The method of claim 7, wherein when the second laser beam is applied onto the brittle substrate, the coolant is applied onto a region of the brittle substrate which is located at a distance of less than 50 millimeters from the second laser spot.

10. The method of claim 1, wherein the coolant is at least one of gas and liquid.

11. The method of claim 10, wherein the gas is selected from a group consisting of air, cooling oil, helium gas, nitrogen, CO₂ and any combination thereof.

12. The method of claim 10, wherein the liquid is selected from a group consisting of pure water, alcohol, acetone, isopropanol, cooling oil, liquid nitrogen, liquid helium and any combinations thereof.
